(19) United States
(12) Patent Application Publication
(10) Pub. No.: US 2012/0085567 A1
(43) Pub. Date: Apr. 12, 2012

(54) ELECTRICAL INSULATION MATERIALS AND METHODS OF MAKING AND USING SAME

(75) Inventors: Timothy S. Lintz, Waterford, NY (US); John D. Albert, Pennsburg, PA (US); Donald R. Mcgivern, Latham, NY (US); Eric T. Pompey, Green Island, NY (US)

(73) Assignee: LYDALL, INC., MANCHESTER, CT (US)

(21) Appl. No.: 13/375,879

(22) PCT Filed: Jun. 3, 2010
(86) PCT No.: PCT/US2010/037304

§ 371 Date: Dec. 2, 2011

Related U.S. Application Data
(60) Provisional application No. 61/184,126, filed on Jun. 4, 2009.

(51) Int. Cl. H01B 3/30; D21H 25/00; B31F 1/12; D21H 13/16

(52) U.S. Cl. 174/110 SR; 162/157.3; 162/111

(57) ABSTRACT

Electrical insulation material comprising a fiber component, a binder element, and a dielectric additive and having a dielectric strength measured in air in the range of from about 8.9 MV/m (225 V/mil) to about 15.7 MV/m (325 V/mil), a dielectric strength measured in oil of greater than about 23.6 MV/m (600 V/mil), and a continuous use temperature of from about −30 C (−22 F) to about 220 C (428 F). A method of making electrical insulation material, comprising preparing an aqueous slurry comprising a fiber component, forming the slurry into a sheet, saturating the sheet with a saturant, wherein the saturant comprises a binder and a dielectric additive, and drying the saturated sheet. A method comprising preparing an aqueous slurry comprising a fibrillated acrylic fiber, dilution hydroforming the slurry into a sheet, saturating the sheet with a saturant, wherein the saturant comprises a carboxylated styrene-acrylate copolymer and a fluoropolymer, drying the sheet, and providing the sheet for use as insulation on an electrical conductor.

### FIELD OF INVENTION

This disclosure relates to electrical insulation materials and methods of making and using same.

### BACKGROUND OF INVENTION

An electrical insulating material, also termed an insulator or a dielectric, is a material that resists the flow of electric current. Various insulating materials are used in parts of electrical equipment, and function to support or separate electrical conductors without passing current through themselves.

Historically, two main types of electrical insulation have been used to insulate electrical conductors (e.g., wires) used in electrical equipment or components such as electrical transformers or motors. The first type comprises wet-laid cellulosic-based materials (i.e., cellulose paper), which are characterized by their excellent electrical insulation characteristics due to a high degree of formation uniformity, that is, they have very tight structure with few if any pin holes. Further, cellulose papers yield very high machine-direction tensile strength which is an important feature during the wrapping of the insulation on the electrical conductor. However, cellulose papers have one key performance shortfall which limits their ability to be used across all electrical insulation applications—a low continuous use temperature. Herein, the continuous use temperature refers to the highest constant temperature at which a material will survive relative to the application requirements and service environment.

Per the Institute of Electrical and Electronics Engineers (IEEE) C57.91 standard, cellulose papers are approved for use in applications requiring insulating media that can withstand continuous use temperatures up to 95° C. (203° F.) for “natural” kraft or up to 110° C. (230° F.) for “thermally upgraded/nitrogen-treated” kraft. Above these temperatures the cellulose paper rapidly degrades resulting in more frequent replacement of the insulating material.

The second type of electrical insulation is made from synthetic fibers, which are typically used in electrical applications that require the insulation to have a continuous use temperature in excess of 220° C. (428° F.). A commercial example of this type of electrical insulation is NOMEX, which is a meta-aramid fiber that is considered to be an aromatic nylon available from DuPont Corporation. While NOMEX is able to withstand continuous use temperatures in excess of 220° C. (428° F.), it is typically in limited supply and significantly more expensive than cellulose papers.

Therefore, there is a continuing need to develop a relatively inexpensive insulating material having desirable thermal and mechanical properties, especially for continuous use temperatures above those for cellulose papers (greater than about 110° C./230° F.) and below those for NOMEX (less than about 220° C./428° F.).

### SUMMARY OF INVENTION

Disclosed herein is electrical insulation comprising a fiber component, a binder element, and a dielectric additive. Further disclosed herein is nonwoven, electrical insulation sheet or tape comprising a fiber component, a binder element, and a dielectric additive. Further disclosed herein is electrical insulation material comprising a fiber component, a binder element, and a dielectric additive and having a dielectric strength measured in air in the range of from about 8.9 MV/m (225 V/mil) to about 12.8 MV/m (325 V/mil), a dielectric strength measured in oil in the range of from about 9.4 MV/m (240 V/mil) to about 27.6 MV/m (700 V/mil), and a continuous use temperature of from about −30° C. (−22° F.) to about 220° C. (428° F.). The fiber component may comprise acrylic fibers, synthetic fibers, synthetic pulps, lyocell fibers, meta-aramids, paraaramids, polyphenylene sulfide fibers, poly(butylene terephthtalate) fibers, poly(ethylene terephthalate) fibers, polypropylene fibers, polyethylene fibers, fiberglass fibers, clay fiber, or combinations thereof. The fiber component may have a length in the range of from about 0.25 mm to about 12.5 mm and an aspect ratio of from about 500 to about 250,000. The fiber may be fibrillated, for example nanofibrillated. The insulation may comprise from about 50 to about 95 weight percent of the fiber component based upon the total weight of the insulation, alternatively from about 65 to about 90 weight percent, alternatively from about 75 to about 85 weight percent. The binder element may comprise emulsion polymers styrene acrylates, styrene butadienes, acrylics, vinyl acetates, acrylonitriles resins, urethanes, epoxies, urea formaldehyde, melamine formaldehyde, solution polymers, acidified acrylics, polyvinyl alcohols, or combinations thereof. The binder element may comprise a functionalized polymer. The binder element may comprise a carboxylated copolymer, for example having a molecular weight of from about 1×10⁵ g/mole to about 1×10⁷ g/mole. The binder element may comprise a carboxylated styrene-acrylate copolymer. The insulation may comprise from about 3 to about 40 weight percent of the binder element based upon the total weight of the insulation, alternatively from about 5 to about 25 weight percent, alternatively from about 10 to about 20 weight percent. The dielectric additive may comprise fluoropolymers, neoprene, bakelite, silicone or combinations thereof. The fluoropolymers may comprise polytetrafluoroethylene (PTFE), perfluoroalkoxy polymer (PFA), fluorinated ethylene-propylene (FEP), or combinations thereof. The dielectric additive may have a dielectric strength of from about 40 MV/m (1,016 V/mil) to about 80 MV/m (2,032 V/mil). The dielectric additive may have a particle size in the range of from about 50 nm to about 500 nm, alternatively from about 200 to about 300 nm and a surface area in the range of from about 7.85 um² to about 785 um². The insulation may comprise from about 1 to about 30 weight percent of the dielectric additive based upon the total weight of the insulation, alternatively from about 2 to about 20 weight percent, alternatively from about 3 to about 10 weight percent.

Disclosed herein is a sheet or tape formed from the electrical insulation comprising a fiber component, a binder element, and a dielectric additive. The sheet may have a 7.3 psi (0.51 kg/cm²) thickness of from about 0.0015 inches (0.0381 mm) to about 0.0150 inches (0.381 mm), a weight of from about 15 lbs/2880 ft² (25.4 g/m²) to about 80 lbs/2880 ft² (135.6 g/m²), a machine direction (MD) tensile strength of from about 10 lbs/inch (4.5 kg/25.4 mm) width to about 100 lbs/inch (45.4 kg/25.4 mm) width, a dielectric strength of from about 225 V/mil (8.9 MV/m) to about 325 V/mil (12.8 MV/m) measured in air, a dielectric strength of from about 240 V/mil (9.4 MV/m) to about 700 V/mil (27.6 MV/m) measured in mineral oil, an elongation value in the machine direction of from about 20% to about 40% and an elongation value in the transverse direction of from about 20% to about 40%, a continuous use temperature of from about −30° C. (−22° F.) to about 220° C. (428° F.), a mineral oil absorption of from about 100% to about 150%, or combinations thereof. Further disclosed herein is an insulated conductor comprising an electrical conductor wrapped with the sheet or tape. The electrical conductor may comprise electrical wires, electrical conduits, battery components, an electric motor internal, magnet wire, or an electric transformer internal wrapped with the electrical insulation.

Disclosed herein is a method of making electrical insulation material, comprising preparing an aqueous slurry comprising a fiber component; forming the slurry into a sheet; saturating the sheet with a saturant, wherein the saturant comprises a binder and a dielectric additive; and drying the saturated sheet. Further disclosed is a product, e.g., electrical insulation, of such process. In an embodiment, the fiber component is a fibrillated acrylic fiber and is present in the slurry in an amount of from about 0.1 (w/w) % to about 3.0 (w/w) %; the binder element is a carboxylated styrene-acrylate copolymer and is present in the saturant in an amount of from about 10 (w/w) % to about 20 (w/w) %; and the dielectric additive is a fluoropolymer dispersion and is present in the saturant in an amount of from about 1 (w/w) % to about 10 (w/w) %. The dielectric additive may be dispersed in the binder element to form the saturant. The saturant may further comprise a wetting agent in an amount of from about 0.05 (w/w) % to about 2.00 (w/w) %. The method may further comprise uniaxially or biaxially orienting the fibers in the sheet. The method may further comprise creping the sheet, for example wet or dry creping, to form a creped sheet. The method may further comprise creping and/or calendaring the sheet. The creped sheet may have an elongation value in the machine direction of from about 30% to about 50% and an elongation value in the cross direction of from about 30% to about 50%, a mineral oil absorption of from about 140% to about 250% for shorter and finer diameter acrylic fibers, an increase in mineral oil absorption of from about 30% to about 40% when compared to an otherwise similar uncreped sheet, a dielectric strength of from about 280 V/mil (11.0 MV/m) to about 380 V/mil (15.0 MV/m) measured in air, a dielectric strength of from about 300 V/mil (11.8 MV/m) to about 800 V/mil (31.4 MV/m) measured in mineral oil, or combinations thereof.

Disclosed herein is a method comprising preparing an aqueous slurry comprising a fibrillated acrylic fiber; dilution hydroforming the slurry into a sheet; saturating the sheet with a saturant, wherein the saturant comprises a carboxylated styrene-acrylate copolymer and a fluoropolymer; drying the sheet; and providing the sheet for use as insulation on an electrical conductor. The electrical conductor may be housed within an oil-filled transformer, wherein the oil is at a temperature of from about 100° C. (212° F.) to about 220° C. (428° F.). The method may further comprise creping the sheet. The method may further comprise creping and/or calendaring the sheet.

Disclosed herein is a method comprising obtaining an electrical insulation sheet or tape comprising a fibrillated acrylic fiber, a carboxylated styrene-acrylate copolymer and a fluoropolymer; covering at least a portion of an electrical conductor with the sheet or tape; and providing the electrical conductor for use in oil-filled electric transformers, wherein the oil is at a temperature of from about 100° C. (212° F.) to about 220° C. (428° F.). The electrical insulation may have a dielectric strength measured in air in the range of from about 8.9 MV/m (225 V/mil) to about 12.8 MV/m (325 V/mil), a dielectric strength measured in oil in the range of from about 9.4 MV/m (240 V/mil) to about 27.6 MV/m (700 V/mil). The electrical insulation may have a dielectric strength measured in air in the range of from about 8.9 MV/m (225 V/mil) to about 12.8 MV/m (325 V/mil), a dielectric strength measured in oil in the range of greater than about 23.6 MV/m (600 V/mil).

Disclosed herein is a method comprising preparing a slurry comprising a fibrillated acrylic fiber; dilution hydroforming the slurry into a sheet; saturating the sheet with a saturant, wherein the saturant comprises a carboxylated styrene-acrylate copolymer and a fluoropolymer; drying the sheet; forming the sheet into a wrap or tape; covering at least a portion of an electrical conductor with the wrap or tape; and contacting at least a portion of the electrical conductor with a mineral oil.

Disclosed herein is a method comprising preparing a slurry comprising a fibrillated acrylic fiber, a carboxylated styrene polymer and a fluoropolymer; forming the slurry into a sheet or tape; covering at least a portion of an electrical conductor with the sheet or tape; and contacting at least a portion of the electrical conductor with an oil. The mineral oil may be at a temperature of from about 100° C. to about 220° C., for example the mineral oil may be housed within an electrical transformer.

Disclosed herein is a method comprising obtaining an electrical insulation sheet or tape comprising a fibrillated acrylic fiber, a carboxylated styrene-acrylate copolymer and a fluoropolymer; covering at least a portion of an electrical conductor with the sheet or tape; and providing the electrical conductor for use in oil-filled electric transformers.

Disclosed herein is a method comprising preparing a slurry comprising a fibrillated acrylic fiber; dilution hydroforming the slurry into a sheet; saturating the sheet with a saturant, wherein the saturant comprises a carboxylated styrene-acrylate copolymer and a fluoropolymer; drying the sheet; forming the sheet into a wrap or tape; and providing the sheet or tape for use as insulation on an electrical conductor in an oil-filled electric transformer.

Disclosed herein is a method comprising obtaining an electrical insulation sheet or tape comprising a fibrillated acrylic fiber, a carboxylated styrene-acrylate copolymer and a fluoropolymer; covering at least a portion of an electrical conductor with the sheet or tape; placing the electrical conductor inside an electric transformer housing, and placing oil within the transformer housing to contact (e.g., saturate) the electrical insulation sheet or tape. Alternatively, the oil may be placed in the transformer housing prior to, concurrent with, and/or subsequent to placement of the electrical conductor inside the transformer housing. The electrical conductor may be a coil or winding of a continuous electrical conducter (e.g., wire). In an embodiment, the electrical insulation sheet or tape has been calendered and/or creped (or microcreped).

Disclosed herein is a method comprising obtaining an electrical transformer internal component wrapped with an electrical insulation sheet or tape comprising a fibrillated acrylic fiber, a carboxylated styrene-acrylate copolymer and a fluoropolymer; placing the internal component inside an electric transformer housing, and placing oil within the transformer housing to contact (e.g., saturate) the electrical insulation sheet or tape. Alternatively, the oil may be placed in the transformer housing prior to, concurrent with, and/or subsequent to placement of the internal component inside the transformer housing. The internal component may comprise a coil or winding of a continuous electrical conducter (e.g., wire). In an embodiment, the electrical insulation sheet or tape has been calendered and/or creped (or microcreped).

Disclosed herein is electrical insulation material comprising a fiber component, a binder element, and a dielectric additive and having a dielectric strength measured in air in the range of from about 8.9 MV/m (225 V/mil) to about 15.7 MV/m (325 V/mil), a dielectric strength measured in oil of greater than about 23.6 MV/m (600 V/mil), and a continuous use temperature of from about −30° C. (−22° F.) to about 220° C. (428° F.). The sheet or tape may have a machine direction (MD) tensile strength of from about 10 lbs/inch width (4.5 kg/25.4 mm) to about 100 lbs/inch width (45.4 kg/25.4 mm). The sheet or tape may have an elongation value in the machine direction of from about 20% to about 40% and an elongation value in the transverse direction of from about 20% to about 40%.

Further disclosed herein is a method comprising forming a sheet comprising a fibrillated acrylic fiber, a carboxylated styrene-acrylate copolymer and a fluoropolymer, creping and/or hot calendering the sheet, and providing the sheet for use as insulation on an electrical conductor.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the embodiments disclosed herein, reference will now be made to the accompanying drawings in which:

FIG. 1 is a flow diagram of a sheet making process.

FIG. 2 is a photograph of uncreped (i.e., flat) and creped sheet material according to the present disclosure.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . ”.

### DETAILED DESCRIPTION

Disclosed herein is an electrical insulation material (EIM) and methods of making and using same. In an embodiment, the EIM comprises a fiber component, a dielectric additive, and a binder element. In another embodiment, the EIM comprises a fiber component, a dielectric additive, a binder element, and a wetting agent. In an embodiment, the EIM disclosed herein is formed into a sheet such as an electrical insulation sheet (EIS), which may be used to wrap an electrical conductor to form an insulated electrical conductor (IEC). Such EIMs, EISs, IECs and methods of making and using same are described herein in detail.

In an embodiment, the EIM of this disclosure is formed into a nonwoven EIS via a conventional paper making process. Any suitable paper/sheet making process or method is contemplated and therefore is within the scope of this disclosure. A suitable paper/sheet making process may generally comprise preparing a sheet-making slurry (SMS) comprising the main fiber component, forming or casting the SMS into a sheet, saturating the sheet with a sheet binder slurry (SBS), and drying the sheet. Generally, the SMS is formed by suspending the main fiber component in water to form a slurry. The SMS is placed on a wire or screen and vacuum cast to form a mat. The newly formed mat is then saturated (with or without vacuum) with the SBS which contains the binder element and the dielectric additive. The mat is then dried to a shape-sustaining form to produce a nonwoven paper sheet.

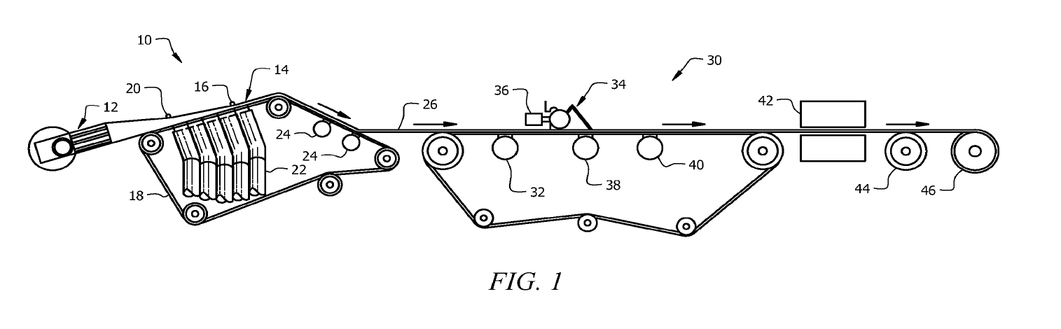

For example, an EIS may be produced using a conventional DELTAFORMER dilution hydroformer device (e.g., an inclined wire former) available from Glens Falls Interweb, Inc. Referring to FIG. 1, a DELTAFORMER device 10 is shown having a typical headbox 12 that may be equipped with an inlet header and a turbulence generator. A solids/liquid ratio may be set within the header, for example from about 0.5 to about 1.0 wt % solids and the remainder liquid (e.g., water). A SMS (sometimes referred to as a furnish or stock slurry) may be fed to the headbox 12 via the inlet header and exits the headbox as a free jet 14 from slice opening 16, which is a space formed between the forming wire 18 and a lip of a pond regulator. The pond regulator provides a mechanical adjustment for the slice opening 16 and a heel opening 20 such that the velocity of the slurry exiting the headbox can be matched to the velocity of the forming wire 18. Accordingly, the angle of impingement of the free jet 14 and its point of impact can be different for different processes and forming geometry. As the fibers are deposited onto the forming wire 18, water is removed, for example via free drainage, vacuum forming box 22, and/or vacuum foils 24. A formed sheet 26 of nonwoven fibers is separated from the forming wire and recovered as a continuous web or sheet.

The newly-formed fiber web is then further processed in any suitable manner such as further dewatering, saturation binding, drying, winding and/or converting to the desired product form. In an embodiment, saturation binding is carried out by applying the SBS to the web using an applicator 30. In an embodiment, the applicator is a microflow applicator 34 available from Glens Falls Interweb, Inc. The incoming web 26 is held in place by the hold down box 32 (e.g., via vacuum) and travels through the microflow applicator 34 (e.g., from left to right as pictured). The SBS may be fed to microflow applicator 34 via input 36, which flows over a weir and is applied to the sheet as a flow curtain/wall. In alternative embodiments, the SBS may be applied to the sheet using alternative applicators such as sprayers. Excess binder is recovered via an applicator box 38 (e.g., a vacuum box that draws binder through the web and removes excess binder) and/or binder control box 40, which may remove excess binder via gravity and/or vacuum assist. In an embodiment, the binder-saturated sheet is dried in one or more convection ovens 42 and/or on one or more dryer cans 44 and drying may be carried out at any temperature that will not substantially degrade the EIM components. The drying temperature may be in the range of from about 121° C. (250° F.) to about 232° C. (450° F.), alternatively from about 138° C. (280° F.) to about 216° C. (420° F.), alternatively from about 154° C. (310° F.) to about 199° C. (390° F.). Upon drying, the sheet may be wound into a roll 46, and further processed or stored as desired.

In an embodiment, commercial quantities of EIS may be produced on a DELTAFORMER machine which produces a fiber web, applies binder to the fiber web via a curtain wall saturator, and employs a combination of convection ovens and dryer cans for drying and curing. Alternatively, the EIS may be produced on other types of paper machines, such as ROTOFORMER and ROTOFORMER 2000 machines (e.g., vacuum cylinder formers) available from Glens Falls Interweb, Inc., Fourdrinier machines, twin-wire formers, hatchet machines, wet-laid board machines, with a variety of binder delivery systems, such as beater-add, spray, coaters/curtains and the like.

In an embodiment, the EIS is further processed by calendering the sheet. Calendering of the EIS may function to smooth, glaze and/or reduce the thickness of the sheet. The calendering may be carried out on-line as part of the sheet making process of FIG. 1, for example by running the sheet 26 through one or more pairs of calender rollers located downstream of the dryers, e.g., between dryer can 44 and roll 46. In such an embodiment, roll 46 would comprise calendered sheet material. In an alternative embodiment, roll 46 comprises non-calendered sheet that is subsequently unrolled and subjected to an off-line calendering process, for example prior to a slitting and/or wrapping process employed by an end user such as an insulated electrical conductor manufacturer. The calendering may be carried out in combination with creping and may occur in either order, e.g., calendering followed by creping or vice-versa. The calendering may be carried out by any suitable process or equipment, for example running the sheet between a plurality of rollers or plates in order to smooth, glaze, and/or thin the sheets. One or more rollers or plates may be heated and the sheet subjected to hot calendering. In an embodiment, the sheet may comprise a heat sensitive or activated binder, and the sheet is subjected to on-line, hot calendering to further aid in setting the binder. In such an embodiment, the calender roll may be operated under any conditions compatible with the materials described herein and able to produce a material having the properties described herein. For example, calendering of the materials described herein may be carried out utilizing a calender roll operating at a temperature of greater than about 200° F., alternatively about 250° F., alternatively about 270° F., and a pressure of about 1000 psi. The temperature of the calendar rolls may be adjusted by any suitable methodology. For example, the calender rolls may contain oil which can be electrically heated to the aforementioned temperatures. In an embodiment, calendering improves one or more properties of the EIS (e.g., dielectric strength, thickness, elongation, conformability to complex shapes or geometries, etc.) in comparison to non-calendered EIS. As will be understood by one of ordinary skill in theart, calendering of the sheet may increase the sheet width. For example a sheet having a width of about 18 inches prior to calendering may have a width equal to or less than about 22 inches subsequent to calendering. One of ordinary skill in the art may adjust one or more conditions of the calendering process to obtain a material having a width meeting one or more user and/or process desired needs.

In an embodiment, the EIM comprises a fiber component. The fiber component provides a high surface area, bulk material forming the nonwoven, fibrous web or matrix of the resultant sheet. Any fiber capable of performing this function and compatible with the other EIM components may be suitable for use in this disclosure.

In an embodiment, the fiber component is a dielectric (i.e., a nonconducting substance). For example, the fiber component may have a dielectric strength of from about 1 MV/m (25 V/mil) to about 60 MV/m (1,524 V/mil), alternatively from about 5 MV/m (127 V/mil) to about 40 MV/m (1,016 V/mil), alternatively from about 10 MV/m (254 V/mil) to about 30 MV/m (762 V/mil). Herein, the dielectric strength refers to the maximum electric field strength that a material can withstand intrinsically without breaking down.

In embodiments, the fiber component has a dielectric constant (also known as relative dielectric constant, relative static permittivity, static dielectric constant, or static relative permittivity) in the range of from about 1 to about 7, alternatively from about 2 to about 6, alternatively from about 2.5 to about 3.5. Herein, the dielectric constant refers to a measure of the extent that a material concentrates electrostatic lines of flux. It is the ratio of the amount of stored electrical energy when a potential is applied, relative to the permittivity of a vacuum.

The fiber component may be further characterized by a length in the range of from about 0.25 mm (0.0098 in) to about 12.5 mm (0.492 in), alternatively from about 1 mm (0.0394 in) to about 10 mm (0.394 in), alternatively from about 3 mm (0.118 in) to about 6 mm (0.236 in) and an aspect ratio in the range of from about 500 to about 250,000, alternatively from about 2,500 to about 65,000, alternatively from about 10,000 to about 30,000.

In an embodiment, the fiber component is fibrillated. Alternatively, the fiber is nanofibrillated. Herein, fibrillation refers to a process that produces a structural change in the walls of chemical pulp fibers during beating which yields finer fiber diameters with fewer surface imperfections and, subsequently, stronger fibers. Herein, a nanofibrillated fiber refers to fiber diameters in the range of 50 nm to 500 nm. Methods of preparing a fibrillated and/or nanofibrillated fiber are known to those of ordinary skill in the art with the aid and benefit of this disclosure. The degree of fibrillation can be quantified using any suitable methodology known to one of ordinary skill in the art such as for example scanning electron microscopy or surface area measurements via BET N₂ gas absorption.

Nonlimiting examples of fibers suitable for use in this disclosure include acrylic fibers, synthetic fibers, synthetic pulps, lyocell fibers, meta-aramids, para-aramids, polyphenylene sulfide fibers, poly(butylene terephthtalate) fibers, poly(ethylene terephthalate) fibers, polypropylene fibers, polyethylene fibers, fiberglass fibers, clay fibers, or combinations thereof. Additional examples of fibers suitable for use in this disclosure include without limitation the A010 series of acrylic fibers which are nanofibrillated acrylic fibers commercially available from Eftec.

In an embodiment, the fiber component is present in the SMS in an amount of from about 0.1 weight/weight % (w/w %) to about 3 w/w %, alternatively from about 0.5 w/w % to about 2.0 w/w %, alternatively from about 0.75 w/w % to about 1.25 w/w %. The fiber component may be present in the EIS in an amount, by total dry weight of the sheet, of from about 30 weight percent (wt. %) to about 90 wt. %, alternatively from about 50 wt. % to about 70 wt. %, alternatively from about 55 wt. % to about 65 wt. %.

In an embodiment, the EIM comprises a dielectric additive. The dielectric additive may function to provide the EIS with an electrical insulating ability greater than that imparted by the fiber component alone. Any dielectric material capable of performing this function and compatible with the other EIM components may be suitable for use in this disclosure.

In an embodiment, the dielectric additive may be characterized by a surface area of from about 7.85 um² to about 785 um², alternatively from about 31 um² to about 503 um², alternatively from about 126 um² to about 283 um². Further, the dielectric additive may be characterized by a dielectric strength of from about 40 MV/m (1,016 V/mil) to about 80 MV/m (2,032 V/mil), alternatively from about 50 MV/m (1,270 V/mil) to about 70 MV/m (1,778 V/mil), alternatively from about 55 MV/m (1,397 V/mil) to about 65 MV/m (1,651 V/mil) and a dielectric constant in the range of from about 1.75 to about 2.25, alternatively from about 1.80 to about 2.20, alternatively from about 1.85 to about 2.15.

The dielectric additive may have a number average particle size distribution in the range of from about 50 nm to about 500 nm, alternatively from about 100 nm to about 400 nm, alternatively from about 200 nm to about 300 nm.

In an embodiment, the dielectric additive comprises fluoropolymers, neoprene, bakelite, silicone, or combinations thereof. In an embodiment, the dielectric additive comprises a fluoropolymer, polytetrafluoroethylene (PTFE), perfluoroalkoxy polymer (PFA), fluorinated ethylene-propylene (FEP), or combinations thereof. In an embodiment, the dielectric additive comprises PTFE dispersed in water with an adhesion promoter. A nonlimiting example of a dielectric additive suitable for use in this disclosure is AD-10A, which is a PTFE dispersion commercially available from Laurel Products LLC. Without wishing to be limited by theory, the use of a dielectric additive of the type described herein that contains high surface area PTFE whiskers may bolster the electrical insulating properties of the EIS. Furthermore, the fluorine groups in the PTFE make the EIS a flame retardant material, which is another feature that may make the disclosed materials (i.e., EIM and EIS) advantageously utilized in electrical insulation applications.

The dielectric additive may be present in the SBS in an amount of from about 1 w/w % to about 10 w/w %, alternatively from about 3 w/w % to about 7 w/w %, alternatively from about 4 w/w % to about 6 w/w %. In some embodiments, the dielectric additive is present in the EIS in an amount, by total dry weight of the sheet, of from about 1 wt. % to about 30 wt. %, alternatively from about 2 wt. % to about 20 wt. %, alternatively from about 3 wt. % to about 10 wt. %.

In an embodiment, the EIM comprises a binder element. Without wishing to be limited by theory the binder element may facilitate the formation of a base sheet with the fiber component; facilitate the interaction of the fiber component and dielectric additive; facilitate dispersion of the dielectric additive in the EIS; provide additional tensile and elongation characteristics to the EIS; impart higher continuous use temperature ratings to the EIS; and/or improve the electrical insulating properties of the EIS. The binder element may comprise any material capable of performing the previously described functions and compatible with the other components of the EIM.

In embodiments, the binder element has a dielectric strength of from about 5 MV/m (127 V/mil) to about 45 MV/m (1,143 V/mil), alternatively from about 10 MV/m (254 V/mil) to about 40 MV/m (1,016 V/mil), alternatively from about 20 MV/m (508 V/mil) to about 30 MV/m (762 V/mil). Further, the binder element may have a dielectric constant measured at 1 kHz frequency in the range of from about 2 to about 4, alternatively from about 2.5 to about 3.5, alternatively from about 2.75 to about 3.25. In other embodiments (e.g., other compositional formulations), dielectric constant values may be measured using a dielectric tester operated at other frequencies (e.g., high, medium, or low frequencies) selected to match a mid-range for the particular material being tested. In an embodiment, the dielectric tester is a Beckman Dielectric Tester Model No. PA5-252-052 available from Beckman Instruments Inc. of Cedar Grove, N.J.

The binder element may comprise a polymeric material having a molecular weight of from 1×10⁵ g/mole to about 1×10⁷ g/mole, alternatively from 5×10⁵ g/mole to about 5×10⁶ g/mole, alternatively from 7.5×10⁵ g/mole to about 2.5×10⁶ g/mole.

In an embodiment the binder element comprises an emulsion polymer, resins, solution polymers, or combinations thereof. Nonlimiting examples of binder elements suitable for use in this disclosure include styrene-acrylates, styrene-butadiene, acrylics, vinyl acetates, acrylonitriles, urethanes, epoxies, urea formaldehyde, melamine formaldehyde, acidified acrylates, polyvinyl alcohol, or combinations thereof. In an embodiment, the binder element comprises a polymer that has been modified to comprise one or more functional groups. For example, the polymer may be functionalized to contain additional carboxylates.

In an embodiment, the binder element comprises a carboxylated polymer, for example having a degree of carboxylation from about 1 mmole/kg to about 12 mmole/kg, alternatively from about 3 mmole/kg to about 10 mmole/kg, alternatively from about 5 mmole/kg to about 8 mmole/kg. Hereinafter, a polymer having a charge density in the disclosed ranges is termed a highly carboxylated polymer. The carboxylated polymer may comprise a carboxylated styrenic polymer, a carboxylated styrene-acrylate copolymer, a highly carboxylated styrenic polymer, a highly carboxylated styrene-acrylate copolymer, or combinations thereof.

In some embodiments, the binder element is a water based binder that may be thermally cured. Alternatively the binder element comprises a carboxylated polymer, a polyalcohol crosslinking agent, and a dispersion component. In an embodiment, the binder comprises ACRODUR 3558 which is a highly carboxylated styrene-acrylate copolymer commercially available from BASF. Without wishing to be limited by theory, the high degree of carboxylation in the ACRODUR 3558 Resin may also provide additional bonding sites thus allowing for an increased amount of the dielectric additive to contact the fiber component.

In an embodiment, the binder element is present in the SBS in an amount of from about 10 w/w % to about 20 w/w %, alternatively from about 12 w/w % to about 18 w/w %, alternatively from about 14 w/w % to about 16 w/w %. In some embodiments, the binder element is present in the EIS in an amount, by total dry weight of the sheet, of from about 3 wt. % to about 40 wt. %, alternatively from about 5 wt. % to about 25 wt. %, alternatively from about 10 wt. % to about 20 wt. %.

As noted previously, the EIM components are suspended in water to form the SMS and the SBS. In an embodiment, the SMS and the SBS include an amount of water sufficient to form a workable slurry and a workable dispersion, respectively. For example, one or more components of the SMS and/or SBS may be suspended in water. The water may be fresh water or mill water wherein mill water refers to water recycled from the papermaking process. The water in the SMS may be present in an amount of from about 97% to about 99.5% based on a wet weight basis, alternatively from about 97.5% to about 99%, alternatively from about 97.75% to about 98.75%. Further, the water in the SBS may be present in an amount of from about 70% to about 90% based on a wet weight basis, alternatively from about 73% to about 87%, alternatively from about 76% to about 84%. In an embodiment, the water constitutes the remainder of the slurry/dispersion when all other components of the SMS/SBS are accounted for.

In an embodiment, the EIM comprises one or more additives as deemed necessary to impart one or more desired physical properties. Examples of additives include without limitation stabilizers, chain transfer agents, antioxidants, ultra-violet screening agents, anti-static agents, fire retardants, fillers, pigments/dyes, coloring agents, and the like.

The aforementioned additives may be used either singularly or in combination to form various formulations of the EIM, e.g., as appropriate to form the SMS and/or EIS. These additives may be included in amounts effective to impart the desired properties. Effective additive amounts and processes for inclusion of these additives to compositions of the type disclosed herein may be determined by one skilled in the art with the aid of this disclosure.

In an embodiment, the EIM further comprises an effective amount of one or more wetting agents. The wetting agent is generally an amphiphilic substance which may function to increase the hydrophilicity of the EIS. Without wishing to be limited by theory, increasing the hydrophilicity of the EIS may advantageously provide decreased degradation and increased stability of the EIS when in contact with oil, for example immersed in oil-filled transformers. The wetting agent may allow for the EIS to exhibit increased oil absorption with a concomitant decrease in physical degradation and/or a decline in performance properties. The wetting agent may ensure better dispersion or homogeneity of the dielectric additive throughout the EIS. This, in turn, enhances the dielectric insulating value of the EIS. In addition to this, the physical strength characteristics of the mat (i.e., tensile, tear, burst, elongation) may be improved because of the EIS's bolstered resistance to thermal degradation as a result of the uniform scattering of the PTFE whiskers.

In an embodiment, the wetting agent comprises an ionic surfactant, a nonionic surfactant, or combinations thereof. The ionic surfactants may comprise anionic surfactants, cationic surfactants, and zwitterionic surfactants such as for example perfluorooctanoate; perfluorooctanesulfonate; sodium dodecyl sulfate, ammonium lauryl sulfate, and other alkyl sulfate salts; sodium laurel sulfate, also known as sodium lauryl ether sulfate; alkyl benzene sulfonate; cetyl trimethylammonium bromide also termed. hexadecyl trimethyl ammonium bromide, and other alkyltrimethylammonium salts; cetylpyridinium chloride; polyethoxylated tallow amine; benzalkonium chloride (BAC); benzethonium chloride; dodecyl betaine; cocamidopropyl betaine; cocoampho glycinate; or combinations thereof. The nonionic surfactants may comprise alkyl poly(ethylene oxides), alkylphenol poly(ethylene oxides), copolymers of poly(ethylene oxide) and poly(propylene oxide), alkyl polyglucosides, or combinations thereof. An example of a wetting agent suitable for use in this disclosure is TRITON X-100 (C₁₄H₂₂O(C₂H₄O)ₙ) which is a nonionic surfactant that is widely commercially available.

In some embodiments, the wetting agent element is present in the SBS in an amount of from about 0.05 w/w % to about 2 w/w %, alternatively from about 0.1 w/w % to about 1 w/w %, alternatively from about 0.2 w/w % to about 0.5 w/w %.

In an embodiment, an SMS is formed by contacting a fiber component comprising a nanofibrillated acrylic fiber and water. An SBS may be formed by contacting a dielectric additive comprising a PTFE dispersion, a binder element comprising a highly carboxylated styrene-acrylate material, and water. In such embodiments, the nanofibrillated acrylic fiber may be present in an amount of from about 0.5 wt. % to about 2 wt. % based upon the total weight of the SMS. In the SBS, the PTFE dispersion may be present in an amount of from about 1 wt. % to about 10 wt. %, the highly carboxylated styrene-acrylate may be present in an amount of from about 9 wt. % to about 20 wt. %, and water may be present in an amount of from about 70 wt. % to about 90 wt. %, wherein the individual amounts for each ingredient are selected within the given ranges such that they total 100% for the composition. The SMS and SBS may be introduced to a paper/sheet making device of the type previously described herein or may be formed into a handsheet as will be described in greater detail later herein. The resultant nonwoven EIS may possess physical and/or mechanical properties that render the material suitable for use as an electrical insulation material. Further processing of the formed sheet may be carried out as known to one of ordinary skill in the art. In an embodiment, the sheet is cut/slit to form tapes or wraps comprising an EIM of this disclosure. Hereinafter the disclosure will focus on the properties of an EIS formed via a conventional paper-making process although formation of an EIS via other processes is contemplated. Also, use of the terms “EIS” or “sheet” should be understood to include sheets of any width or thickness (unless otherwise defined), and include cut/slit-sheets that form tapes or wraps for use in wrapping an electrical conductor Likewise, the terms “EIS” or “sheet” should be understood to include sheets of any rigidness, and thus include flexible sheets or more rigid structures such as boards.

In an embodiment, the EIS has a 7.3 psi (0.51 kg/cm²) thickness in the range of from about 0.0015 inches (0.0381 mm) to about 0.015 inches (0.381 mm), alternatively from about 0.002 inches (0.0508 mm) to about 0.010 inches (0.254 mm), alternatively from about 0.0025 inches (0.0635 mm) to about 0.008 inches (0.203 mm) as determined in accordance with the American Society for Testing and Materials (ASTM) D-202 or the Technical Association of the Pulp and Paper Industry (TAPPI) T-411; and a weight in the range of from about 15 lbs/2800 ft² (25.4 g/m²) to about 80 lbs/2800 ft² (135.6 g/m²), alternatively from about 20 lbs/2800 ft² (33.9 g/m²) to about 75 lbs/2800 ft² (127.2 g/m²), alternatively from about 25 lbs/2800 ft² (42.4 g/m²) to about 45 lbs/2800 ft² (76.3 g/m²) as determined in accordance with ASTM D-646. In an alternative embodiment, the thickness is in the range of from 0.0197 to 0.197 in (0.5 to 5.0 mm). Depending on the thickness desired, different types of machinery such as for example wet-laid board machines may be employed in the manufacture of the EIS. Such devices are known to one of ordinary skill in the art and may be selected with the aid and benefit of this disclosure.

In embodiments, the EIS has a density in the range of from about 0.4 g/cc (25 lbs/ft³) to about 0.7 g/cc (43.7 lbs/ft³), alternatively from about 0.42 g/cc (26.2 lbs/ft³) to about 0.65 g/cc (40.6 lbs/ft³), alternatively from about 0.44 g/cc (27.5 lbs/ft³) to about 0.6 g/cc (37.5 lbs/ft³).

In embodiments, the EIS has an air resistance for a 1.125 inch (2.86 cm) opening in the range of from about 30 secs/100 cc to about 150 secs/100 cc, alternatively from about 80 secs/100 cc to about 145 secs/100 cc, alternatively from about 90 secs/100 cc to about 140 secs/100 cc and a moisture content in the range of from about 0.1% to about 1%, alternatively from about 0.2% to about 0.8%, alternatively from about 0.3% to about 0.5%. Herein, the air resistance refers to forces that oppose the relative motion of air through an object and may be determined in accordance with TAPPI T-460, also referred to as the Gurley method. Herein, the moisture content refers to the amount of moisture present and measurable in the sheet. The amount of moisture in a sheet will vary according to the surrounding conditions and the amount of moisture that is added during production and may be determined by any suitable methodology such as for example thermogravimetric analysis or by TAPPI T-412.

In some embodiments, the EIS has a tensile strength in the machine direction (MD) in the range of from about 10 lbs/inch (4.5 kg/25.4 mm) to about 100 lbs/inch (45.4 kg/25.4 mm), alternatively from about 20 lbs/inch (9.1 kg/25.4 mm) to about 50 lbs/inch (22.7 kg/25.4 mm), alternatively from about 30 lbs/inch (13.6 kg/25.4 mm) to about 40 lbs/inch (18.1 kg/25.4 mm) and a tensile strength in the cross or transverse direction (CD or TD) in the range of from about 10 lbs/inch (4.5 kg/25.4 mm) to about 30 lbs/inch (13.6 kg/25.4 mm), alternatively from about 15 lbs/inch (6.8 kg/25.4 mm) to about 25 lbs/inch (11.3 kg/25.4 mm), alternatively from about 18 lbs/inch (8.2 kg/25.4 mm) to about 22 lbs/inch (10.0 kg/25.4 mm). Herein, the tensile strength refers to the resistance of a material to longitudinal stress (tension) and may be determined in accordance with ASTM D-828 or TAPPI T-494.

In an embodiment, the EIS has a MD tensile index in the range of from about 25 N*m/g to about 310 N*m/g, alternatively from about 55 N*m/g to about 181 N*m/g, alternatively from about 90 N*m/g to about 157 N*m/g and a CD tensile index in the range of from about 48 N*m/g to about 138 N*m/g, alternatively from about 52 N*m/g to about 129 N*m/g, alternatively from about 73 N*m/g to about 116 N*m/g. Herein, the tensile index refers to the tensile strength per basis weight and may calculated using the equation: tensile index=tensile strength (N/m)/basis weight (g/m²).

In an embodiment, the EIS has a MD elongation value in the range of from about 20% to about 40%, alternatively from about 25% to about 35%, alternatively from about 28% to about 32% and a CD elongation value in the range of from about 20% to about 40%, alternatively from about 25% to about 35%, alternatively from about 28% to about 32%. Herein, the elongation value refers to the amount of stretch present and measurable in the sheet and may be determined in accordance with ASTM D-828 or TAPPI T-494.

In an embodiment, the EIS has a bursting strength in the range of from about 103 MN/m² (15 psi) to about 414 MN/m² (60 psi), alternatively from about 138 MN/m² (20 psi) to about 379 MN/m² (55 psi), alternatively from about 172 MN/m² (25 psi) to about 345 MN/m² (50 psi) and a bursting index in the range of from about 3.0 MN/g to about 4.5 MN/g, alternatively from about 3.3 MN/g to about 4.2 MN/g, alternatively from about 3.6 MN/g to about 3.9 MN/g. Herein, the bursting strength refers to the resistance of paper to rupture as measured by the hydrostatic pressure required to burst it when a uniformly distributed and increasing pressure is applied to one of its sides while the bursting index refers to the ratio of the bursting strength (expressed in MegaNewtons/m²) and the basis weight of the paper/paperboard (expressed in g/m²). The bursting strength may be determined in accordance with TAPPI T-403, which may be carried out using a Mullen Burst Tester.

In an embodiment, the EIS has a dielectric strength measured in air in the range of from about 8.9 MV/m (225 V/mil) to about 15.7 MV/m (400 V/mil), alternatively from about 8.9 MV/m (225 V/mil) to about 12.8 MV/m (325 V/mil), alternatively from about 9.6 MV/m (245 V/mil) to about 12 MV/m (305 V/mil), alternatively from about 10.2 MV/m (260 V/mil) to about 10.6 MV/m (270 V/mil) and a dielectric strength measured in oil of greater than about 23.6 MV/m (600 V/mil), alternatively in the range of from about 9.4 MV/m (240 V/mil) to about 31.4 MV/m (800 V/mil), alternatively from about 9.4 MV/m (240 V/mil) to about 27.6 MV/m (700 V/mil), alternatively from about 10.2 MV/m (260 V/mil) to about 23.6 MV/m (600 V/mil), alternatively from about 10.6 MV/m (270 V/mil) to about 23.6 MV/m (600 V/mil).

In an embodiment, the EIS has a continuous use temperature of from about −30° C. (−22° F.) to about 220° C. (428° F.), alternatively from about 20° C. (68° F.) to about 200° C. (392° F.), alternatively from about 100° C. (212° F.) to about 180° C. (356° F.). In an embodiment, the continuous use temperature of the EIS is determined by the continuous use temperature of the components of the EIS, e.g., the fiber component, the binder component, and the dielectric additive, with the lowest continuous use temperature of a given component generally defining that of the EIS as a whole. As would be understood to those skilled in the art, continuous use temperature refers to the recommended temperature at which a material may be used so as to retain acceptable performance (e.g., survive relative to the application requirements) over a required service life. In an embodiment, continuous use temperature is measured in accordance with Underwriters Laboratories (UL) Relative Thermal Index (RTI) standard, UL 746. In an embodiment, the continuous use temperature is defined by the RTI electrical, RTI mechanical with impact, and/or the RTI mechanical without impact according to UL 746.

In an embodiment, the EIS is uniaxially or biaxially oriented (for example during the sheet making process) to impart desirable properties to the EIS (e.g., toughness, opaqueness). In an embodiment, an oriented EIS displays a tensile strength at break (also termed yield/break strength) in the machine direction (MD) of from about 10 lbs/inch (4.5 kg/25.4 mm) to about 100 lbs/inch (45.4 kg/25.4 mm), alternatively from about 20 lbs/inch (9.1 kg/25.4 mm) to about 50 lbs/inch (22.7 kg/25.4 mm), alternatively from about 30 lbs/inch (13.6 kg/25.4 mm) to about 40 lbs/inch (18.1 kg/25.4 mm) and a tensile strength at break (also termed yield/break strength) in the cross direction (CD) of from about 10 lbs/inch (4.5 kg/25.4 mm) to about 30 lbs/inch (13.6 kg/25.4 mm), alternatively from about 15 lbs/inch (6.8 kg/25.4 mm) to about 25 lbs/inch (11.3 kg/25.4 mm), alternatively from about 18 lbs/inch (8.2 kg/25.4 mm) to about 22 lbs/inch (10.0 kg/25.4 mm). The tensile strength at break is the force per unit area required to break a material and may be determined in accordance with ASTM D-828 or TAPPI T-494.

In an embodiment, the tensile elongation at break in the MD ranges from about 20% to about 40%, alternatively from about 25% to about 35%, alternatively from about 28% to about 32% and the tensile elongation at break in the TD (or CD) ranges from about 20% to about 40%, alternatively from about 25% to about 35%, alternatively from about 28% to about 32%. The tensile elongation at break is the percentage increase in length that occurs before a material breaks under tension and may be determined in accordance with ASTM D-828 or TAPPI T-494.

In an embodiment, the EIS has mineral oil absorption that equals the pore volume of the material. In such an embodiment, the EIS may be saturated with oil. Alternatively, the EIS may display mineral oil absorption in an amount that equals or exceeds its own weight. In such an embodiment, the EIS may be said to be supersaturated. For example, an EIS may display mineral oil absorption based on the pre-wetted weight of the EIS in the range of from about 100% to about 150%, alternatively from about 110% to about 140%, alternatively from about 110% to about 120%. Any suitable methodology may be employed to determine the percent absorptive capacity of the EIS in mineral oil. A typical procedure may employ preparing a sample of the EIS and recording the dry weight of the sample. The EIS may then be immersed in mineral oil for a predetermined time period (e.g., 3 minutes) and then excess oil removed by drainage or compression. The sample is then reweighed and the percent absorption calculated as (wet weight-dry weight)/dry weight×100%.

In an embodiment, the EIS has an ash content in the range of from about 0.3% to about 0.6%, alternatively from about 0.35% to about 0.55%, alternatively from about 0.4% to about 0.5%. Herein, ash refers to the residue left after complete combustion of paper at high temperature. It is generally expressed as percent of original test sample and represents inorganic content in the paper.

In an embodiment, the EIS will have a vertical flame track in the range of from about 0 inches to about 4 inches (10.16 cm), alternatively from about 0 inches to about 2 inches (5.08 cm), alternatively from about 0 inches to about 1 inch (2.54 cm). Herein, the flame retardancy refers to the vertical distance a flame will track once the ignition source (e.g., a cigarette lighter) is removed from the edge of the EIS and may be determined by a standardized methodology. For example, the methodology may comprise obtaining a sample of material to be tested. The material is then held in place and using a butane lighter, flame is applied to the lower edge of the sample with approximately 50% of the flame height on the sheet. The flame is held in each location on the sample for approximately 2 seconds. The results are observed and interpreted. A sample is characterized as acceptable if the flame tracks no more than 4 inches (10.16 cm) before self extinguishing while an unacceptable rating is given if the flame tracks more than 4 inches (10.16 cm) in any location.

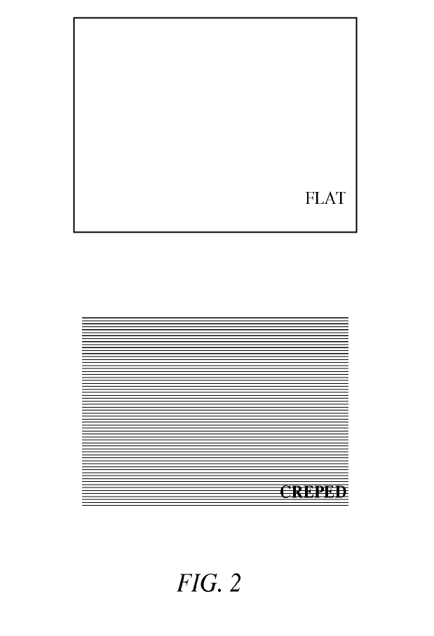

In an embodiment, the EIS is further processed by creping the sheet, such as shown in FIG. 2. Herein, creping refers to the operation of mechanically softening or crinkling a sheet of paper to increase its stretch and softness and may also provide an increased surface area and density attributes, which in turn may provide improved insulating properties.

In some embodiments, the EIS is further processed by in-line creping of the formed sheet. Herein, “in-line creping” may be performed on a machine further equipped with creping components such as a drum roll and a doctor blade so that the EIS may be formed and creped in the same process. For example, referring again to FIG. 1, creping components such as a drum roll and a doctor blade may be placed downstream of the dryers (e.g., downstream of dryer can 44). The EIS may be subjected to wet creping or dry creping. The choice of the type of creping process will depend on economics, equipment availability and user desired properties such as strength and stretch.

In an embodiment, the EIS is further processed by wet creping. Herein, “wet creping” refers to re-wetting the EIS and attaching the rewet sheet to a creping drum or MG dryer. The attached re-wet EIS may then be creped with additional calendering and drying equipment. Any suitable wet creping process is contemplated, such as those disclosed in U.S. Pat. Nos. 6,379,496, 6,855,228 and 4,992,140, which are incorporated herein by reference in their entirety.

In an embodiment, the EIS is further processed by dry creping. Herein, “dry creping” is similar to the wet creping process described previously however the EIS is not re-wet prior to carrying out the process. Any suitable dry creping process is contemplated, such as those disclosed in U.S. Pat. Nos. 2,725,640, 5,865,950, 6,336,995, 6,277,242, 6,207,734, and 5,944,954, which are incorporated herein by reference in their entirety. In either embodiment, the resultant material is termed a creped EIS. In an embodiment, creping is carried out in a process known as microcreping with technology available from Micrex Corporation, for example creping using a Micrex MICROCREPER.

In an embodiment, the creped EIS has an elongation value in the machine direction of from about 30% to about 50%, alternatively from about 35% to about 45%, alternatively from about 37% to about 43% and an elongation value in the cross direction of from about 30% to about 50%, alternatively from about 35% to about 45%, alternatively from about 37% to about 43% as determined in accordance with ASTM D-828 or TAPPI T-494.

In an embodiment, a creped EIS has mineral oil absorption of from about 140% to about 250% based on the weight of the EIS, alternatively from about 160% to about 230%, alternatively from about 180% to about 210%. The creped EIS may display an increase in absorption of from about 30% to about 40%, alternatively from about 32% to about 38%, alternatively from about 34% to about 36%, when compared to an otherwise similar uncreped EIS.

In an embodiment, a creped EIS has a dielectric strength (measured in air) of from about 260 V/mil (10.2 MV/m) to about 400 V/mil (15.7 MV/mil), alternatively 280 V/mil (11.0 MV/m) to about 380 V/mil (15.0 MV/m), alternatively from about 300 V/mil (11.8 MV/m) to about 360 V/mil (14.2 MV/m), alternatively from about 315 V/mil (12.4 MV/m) to about 345 V/mil (13.6 MV/m), as determined in accordance with ASTM D-149 and ASTM D-3487.

In an embodiment, a creped EIS has a dielectric strength (measured in mineral oil) of from about 280 V/mil (11.0 MV/m) to about 440 V/mil (17.3 MV/m), alternatively of from about 300 V/mil (11.8 MV/m) to about 420 V/mil (16.5 MV/m), alternatively from about 320 V/mil (12.6 MV/m) to about 400 V/mil (15.7 MV/m), alternatively from about 330 V/mil (13.0 MV/m) to about 390 V/mil (15.4 MV/m), as determined in accordance with ASTM D-149 and ASTM D-3487.

In embodiments, the EIS or creped EIS (either of which having optionally been calendered), hereinafter referred to collectively as the EIS, is used to wrap an electrical conductor to form an insulated electrical conductor (IEC). In other words, the EIS provides an electrical insulating outer-layer or wrapping to the electrical conductor. In an embodiment, the EIS is applied to an electrical conductor by spirally wrapping the EIS (e.g., a tape or wrap) of this disclosure around the conductor. Any type of electrical conductor is contemplated in this disclosure, for example wire such as copper wire. In an embodiment, the electrical conductor wrapped with an EIS of this disclosure (i.e., the IEC) is subjected to continuous use temperatures of less than about 220° C., alternatively from about 0° C. to about 220° C., alternatively from about 105° C. to about 220° C., alternatively from about 110° C. to about 220° C., alternatively from equal to or greater than 110° C. to equal to or less than 220° C., alternatively from greater than 110° C. to less than 220° C., alternatively from about 120° C. to about 200° C., alternatively in a range of from one of a lower end point of about 100, 105, 110, 115, 120, 125, 130, 135, 140° C. to one of a higher end point of about 180, 185, 190, 195, 200, 205, 210, 215, 220° C. In an embodiment, the continuous use temperature of the electrical conductor is selected to provide acceptable performance over a required service life of an oil-filled electrical transformer. Some non-limiting examples of electrical conductor are electrical wires, electrical conduits, battery components, magnet wire, internal parts of an electric motor, and internal parts of an electric transformer (e.g., transformer core, coils, and windings).

In an embodiment, the IEC is employed in an oil-filled transformer. For example, electrical wire (e.g., copper or copper-alloy wire) may be wrapped with an EIS as disclosed herein to form an IEC. The IEC may be further processed (e.g., wound or coiled) and placed in an electrical transformer housing. In some embodiments, the electrical transformer may be filled with oil (e.g., mineral oil), and the oil may soak into the EIS wrap of the IEC.

In an embodiment, a method comprises preparing a fibrous slurry comprising a nanofibrillated fiber component (e.g., acrylic fiber); vacuum casting the slurry to form a sheet; preparing a saturant comprising a binder element (e.g., a carboxylated styrene polymer) and a dielectric additive (e.g., a fluoropolymer), both of the type described previously herein; saturating the vacuum cast sheet with the saturant; and drying and curing the saturated sheet to form a dried sheet. The method may further comprise creping the dried sheet, sliting the sheet to form a tape, wrapping an electrical conductor with the tape to form an insulated electrical conductor, and contacting the insulated electrical conductor with oil (e.g., within an oil-filled electrical transformer.

In an embodiment, a method comprises preparing a slurry comprising a fibrillated acrylic fiber, a carboxylated styrene polymer and a fluoropolymer; forming the slurry into a sheet or tape; covering at least a portion of an electrical conductor with the sheet or tape; and contacting at least a portion of the electrical conductor with an oil, wherein the oil is at a temperature of from about 100° C. to about 220° C. and wherein the oil is housed within an electrical transformer.

In an embodiment, a method comprises preparing a SMS comprising a nanofibrillated fiber component (e.g., acrylic fiber); a saturant comprising a binder element (e.g., a carboxylated styrene polymer) and a dielectric additive (e.g., a fluoropolymer), all of the type described previously herein. The SMS may be used to prepare a sheet using any suitable sheet forming methodology. The sheet may then be subjected to additional processing. In an embodiment, the sheet is hot calendered. Alternatively, the sheet is creped and/or microcreped. Alternatively, the sheet is hot calendered and then creped. Alternatively, the sheet is hot calendered and then microcreped. Alternatively the sheet is creped and then hot calendered. Alternatively, the sheet is microcreped and then hot calendered. In the aforementioned embodiments, the resultant sheet having been subjected to a calendering and/or creping process is termed the processed sheet. The method may further comprise sliting the processed sheet to form a tape, wrapping an electrical conductor with the tape to form an insulated electrical conductor, and contacting the insulated electrical conductor with oil (e.g., within an oil-filled electrical transformer.

In an embodiment, an EIS of the type described herein having been formed into a sheet is further processed by hot calendering and microcreping (in any order). The processed EIS may then be slit to form a tape, and an electrical conductor wrapped with the tape to form an insulated electrical conductor. The insulated electrical conductor then may be contacted with oil (e.g., within an oil-filled electrical transformer), wherein the EIS material absorbs from about 100% to about 150% of the oil based on the weight of the EIS. Such an EIS may have a continuous use temperature of from about −30° C. (−22° F.) to about 220° C. (428° F.), alternatively from about 20° C. (68° F.) to about 200° C. (392° F.), alternatively from about 100° C. (212° F.) to about 180° C. (356° F.).

In an embodiment, an EIS of the type described herein is advantageously employed in the preparation of an IEC. The EIS of this disclosure provides electrical insulation at continuous temperatures in the aforementioned ranges. Further, at the disclosed EIS thickness, an increased number of insulation wraps can be made within the fixed gap of space allotted for insulation. The increased number of wraps will afford an even higher electrical insulation value due to presence to an increased number of interfaces and air space associated with multiple wraps. Additionally, an EIS having been hot calendered and displaying increases in elongation may afford the wrapping of more complex and/or smaller geometries. The ability to wrap more complex and/or smaller geometries would facilitate the production of IECs having smaller footprints and/or more efficient geometries which in turn beneficially impact the economics of manufacturing and operating the IEC.

### EXAMPLES

The embodiments having been generally described, the following examples are given as particular embodiments of the invention and to demonstrate the practice and advantages thereof. It is understood that the examples are given by way of illustration and are not intended to limit the specification or the claims in any manner.

### Example 1

A typical formulation for a SMS of the type described herein is shown in Table 1.

TABLE 1

| MATERIAL | W/W % OF SHEET |
|---|---|
| EFtec ® A010-4 Acrylic fiber (18% solids) | 80 |
| BASF Acrodur ® DS 3558 Binder Resin (50% solids) | 5 |
| Laurel AD-10A PTFE Dispersion (60% solids) | 5 |

7 in.×7 in. (17.78 cm×17.78 cm) prototypes of an EIS were prepared using the formulation in Table 2 and formed into a nonwoven handsheet.

TABLE 2

| | |
|---|---|
| | QUANTITY FOR |
| MATERIAL | 7 × 7 in. SHEET |

FIBER FURNISH ADDED TO THE HANDSHEET MOLD

| Mill Water | 7 L in bucket and | |
|---|---|---|
| | 7 L in caster | |
| EFtec ® A010-4 Acrylic fiber (18% solids) | 9.47 | wet g |

BINDER SYSTEM ADDED THROUGH
THE SATURATION PROCESS

| | | |
|---|---|---|
| Mill Water | 617 | mL |
| BASF Acrodur ® DS 3558 Binder Resin (50% solids) | 300 | wet g |
| Laurel AD-10A PTFE Dispersion (60% solids) | 83 | wet g |

The handsheet was made as follows: Mill water (7 liters) was added to a stainless steel mixing bucket which was used to mix the water at 20 psi (1.4 kg/cm²). A010-4 acrylic fiber (9.47 g) was added to the mixing bucket and allowed to mix for 5 minutes. An 8 in.×8 in. (20.32 cm×20.32 cm) stainless steel Noble & Wood forming wire was placed into a handsheet mold and the mold was closed and locked. Additional mill water (7 liters) was then added to the handsheet mold. The contents of the mixing bucket were then transferred to the handsheet mold and the materials in the handsheet mold mixed with a perforated plunger (e.g., plunged approximately 20 times). Vacuum was then applied to the handsheet mold and the resulting sheet cast onto a stainless steel forming wire. A second mixture was prepared by contacting 617 ml of mill water, 300 wet g of ACRODUR DS 3558 resin and 83 wet g of AD-10A PTFE dispersion in a 2,000 ml NALGENE beaker and mixing for 5 minutes. The mixture was then transferred to a stainless steel saturating pan. The sheet was transferred from the handsheet mold to a saturating wire and the saturating wire and sheet combination were subjected to a vacuum. The sheet and saturator wire configuration were then skimmed across the top of the binder bath in the stainless steel saturating pan. Once the full length of the sheet had been skimmed, the sheet and saturating wire configuration were again run across the vacuum slot to remove excess binder. The sheet was then transferred from the saturator wire to a dryer using cheese cloth on the top and bottom of the sheet to keep the sheet from sticking to the dryer and dried at 220° C. for 5 minutes. The dried sheet was trimmed to 7 in.×7 in. (17.78 cm×17.78 cm). The physical property data obtained for a sheet made in this manner is summarized in Table 3.

TABLE 3

| PROPERTY | UNIT | QUANTITY |
|---|---|---|
| Basis Weight | lbs/2880 sq.ft. (g/m²) | 29 (49.2) |
| 7.3 psi Thickness | mil inches (mm) | 5 (0.127) |
| Tensile Strength | lbs/inch width | 10 (4.5) |
| | (kg/25.4 mm) | |
| Elongation | % | 5 |

The results demonstrate that standard cellulose-based electrical insulating grades prepared in this manner yielded tensile strength of near 3 lbs/inch width (1.36 kg/25.4 mm). However, when these cellulose-based grades are run on the paper machine, the machine direction tensile strength jump to 60 to 80 lbs/inch width (27.2 to 36.3 kg/25.4 mm). Without wishing to be limited by theory, this jump in tensile strength may be the result of several factors. First, a handsheet has no directionality to it. It is simply formed in a static drainage process without being pulled into a press and/or dryer section like it is on a paper machine. Second, because a handsheet is formed via a static drainage process, a lot of the fibers are locked in the z direction in the final sheet configuration, that is, the fibers cannot overlap with other fibers to impart additional tensile strength. Conversely, materials made on a paper machine do have directionality because fibers in the wet state are being pulled towards the end of the paper machine and, therefore, the majority of these fibers lay down in the xy plane, that is, these fibers overlap each other to impart additional tensile strength. Finally, cellulosic and acrylic fibers are typically refined in-line on a paper machine, which yields much finer diameter fibers with increased surface area, which in turn yields more fiber-to-fiber overlaps and subsequent bonding sites. Therefore, machine-made EIS may exhibit higher tensile strength than a hand-made EIS.

### Example 2

The electrical insulating properties of an EIM of the type disclosed herein was investigated. Eighteen samples designated samples 1-18 were prepared using the formulations given in Table 4.

TABLE 4

| | W/W % OF | QUANTITY FOR | |
|---|---|---|---|
| | SHEET | 7 × 7 in. SHEET | |
| Fiber slurry (SMS) Formulation | | | |
| Mill Water | — | 7L in bucket + | |
| | | 7 L in caster | |
| Eftec Acrylic A010-4 (18.11% solids) | 80 | 8.50 | wet g |
| SATURANT (SBS) FORMULATION | | | |
| Mill Water | — | 616.67 | mL |
| Acrodur DS 3558 (50% solids) | 15 | 300 | wet g |
| Triton X-100 | — | — | |
| Laurel MP-55 PTFE Micropowder | — | — | |
| Laurel AD-10A PTFE Dispersion | 5 | 83.33 | wet g |
| (60% solids) | | | |

The samples were formed into sheets as described previously in Examples 1 and 2. Eighteen 8 in.×8 in. (20.32 cm×20.32 cm) sheets were prepared and trimmed to 7 in.×7 in. (17.78 cm×17.78 cm) each with a target basis weight of 30 lb/2880 sq.ft. (50.86 g/m²). The samples were conditioned at 220° F. (104° C.) and 50% relative humidity for 24 hours in a drying oven. Various properties of the samples, designated samples 1-18, were tested and those properties and their determined values are presented in Table 5. The results demonstrated materials of the types described herein display physical and/or mechanical properties making them suitable for use as EIS and/or EIM. In particular, the results demonstrate desirable dielectric strength that is expected to improve further with machine-made EIS rather than hand-made EIS.

TABLE 5

| | BASIS | | | | | AIR | | TENSILE |
|---|---|---|---|---|---|---|---|---|
| | WEIGHT | 7.3 psi | | | FLAME | RESISTANCE | MULLEN | STRENGTH |
| SAMPLE | (lbs/2880 | THICKNESS | MOISTURE | ASH | TRACK | (secs/100 cc/ | BURST | (lbs/inch |
| # | ft²) | (mil inches) | (%) | (%) | (inches) | 1-⅛″) | (MN/m²) | width) |
| 1 | 29.5 | 4.2 | 0.17 | 0.28 | 3 | 120 | | 10 |
| 2 | 27.8 | 4.2 | | | 3 | 78 | 152 | 11.8 |
| 3 | 26.9 | 4.5 | | | 3 | 66 | 107 | 8.2 |
| 4 | 28.9 | 4.9 | 0.39 | 0.41 | 2 | 100 | 195 | 9.3 |
| 5 | 31 | 4.5 | | | 3 | 125 | 276 | 7.8 |
| 6 | 27.4 | 4.2 | | | 3 | 74 | 118 | 7 |
| 7 | 27.8 | 4.6 | 0.34 | 0.3 | 2 | 81 | 150 | 9.4 |
| 8 | 31.2 | 4.8 | | | 4 | 130 | 270 | 9.7 |
| 9 | 26.9 | 4.5 | | | 2 | 63 | 103 | 9.1 |
| 10 | 28 | 4.9 | 0.42 | 0.44 | 3 | 80 | 159 | 10.7 |
| 11 | 27.6 | 4.4 | | | 3 | 73 | 125 | 9.7 |
| 12 | 28.4 | 5.5 | | | 3 | 89 | 175 | 8.8 |
| 13 | 28.4 | 4.5 | 0.5 | 0.56 | 3 | 92 | 177 | 10.1 |
| 14 | 28.4 | 4.8 | | | 2 | 86 | 180 | 8.3 |
| 15 | 28.9 | 5 | | | 4 | 105 | 190 | 9.8 |
| 16 | 33 | 4.6 | 0.66 | 0.58 | 2 | 148 | 345 | 11.9 |
| 17 | 27.6 | 4.3 | | | 2 | 77 | 131 | 9.4 |
| 18 | 28.5 | 3.9 | | | 3 | 96 | 191 | 10.8 |
| AVG | 28.7 | 4.6 | 0.41 | 0.43 | 2.8 | 94 | 179 | 9.5 |
| STD. DEV. | 1.6 | 0.4 | 0.16 | 0.13 | 0.6 | 24 | 65 | 1.3 |
| RANGE | 6.1 | 1.6 | 0.49 | 0.3 | 2 | 85 | 242 | 4.9 |

| | | | | | DIELECTRIC STRENGTH | | | |
|---|---|---|---|---|---|---|---|---|
| | ELONGATION | | OIL ABSORPTION | | IN AIR | | IN OIL | |
| | (%) | | (%) | | (volts/mil thick)* | | (kV/mil thick)* | |
| SAMPLE | Flat | Micrex | Flat | Micrex | Flat | Micrex | Flat | Micrex |
| # | Sheet | Microcreped | Sheet | Microcreped | Sheet | Microcreped | Sheet | Microcreped |
| 1 | 4.19 | — | 121.44 | — | 233 | — | 247.9 | — |
| 2 | 5.12 | — | 105.53 | — | 259.4 | — | 274.5 | — |
| 3 | 5.53 | — | 94.95 | — | 256.2 | — | 269.7 | — |
| 4 | 4.62 | — | 115.75 | — | 223.8 | — | 239.4 | — |
| 5 | 2.61 | — | 142.08 | — | 242 | — | 254.7 | — |
| 6 | 2.71 | — | 100.21 | — | 266.7 | — | 279.3 | — |
| 7 | 5.03 | — | 104.66 | — | 316 | — | 332.6 | — |
| 8 | 5.01 | — | 143.12 | — | 287.4 | — | 302.5 | — |
| 9 | 4.9 | — | 93.8 | — | 270.2 | — | 285.9 | — |
| 10 | 5.77 | 10.21 | — | 180.65 | — | 312.4 | — | 334.1 |
| 11 | 3.37 | 6.48 | — | 149.19 | — | 332.6 | — | 357.6 |
| 12 | 5.63 | 10.14 | — | 183.23 | — | 330.6 | — | 356.2 |
| 13 | 4.13 | 7.58 | — | 189.33 | — | 287 | — | 313.7 |
| 14 | 3.74 | 6.8 | — | 185.7 | — | 314.3 | — | 338 |
| 15 | 5.96 | 10.87 | — | 206.43 | — | 346.4 | — | 370.5 |
| 16 | 5.36 | 9.57 | — | 235.71 | — | 380.7 | — | 405 |
| 17 | 4.23 | 7.83 | — | 140.26 | — | 363.8 | — | 391.2 |
| 18 | 5.21 | 9.47 | — | 194.55 | — | 348.6 | — | 374.8 |
| AVG | 4.62 | 8.77 | 113.5 | 185.01 | 261.6 | 335.2 | 276.3 | 360.1 |
| STD. DEV. | 1 | 1.62 | 18.75 | 28.39 | 28.3 | 28.5 | 28.8 | 28.8 |
| RANGE | 3.35 | 4.39 | 49.32 | 95.45 | 61.5 | 38.4 | 93.2 | 91.3 |

### Example 3

An EIS of the type described herein was prepared per the following Pilot Rotoformer Trial Design. It should be mentioned here that larger dimension (bigger diameter and longer length) acrylic fiber (0.1d×3 mm Vonnel) had to be added to the Fiber Furnish (SMS) to enhance drainage on the pilot rotoformer and subsequently transfer the sheet to the saturation/binder application part of the process.

TRIAL DESIGN
OBJECTIVE: Produce 10,500′ rolls of variation 1@ 26.5″ width.
FIBER FURNISH:

| MATERIAL | % DRY | DRY LBS. | LBS. AS IS | |
|---|---|---|---|---|
| Machine Chest: (Est. 3 req'd.) | | | | |
| Eftec Acrylic A040-6 Fiber | 22.0 | 14.1 | 64.1 | wet lbs. |
| Mitsubishi Vonnel 0.1 d × 3 mm | 98.5 | 17.3 | 17.6 | wet lbs. |
| Acrylic Fiber | | | | |
| Total Water | — | — | 1328 | gal |

An EIS of the type described herein was produced by the following procedure: with the binder makeup tank slowly agitating and about ½ full of water add 70 lbs, as is, of BASF ACRODUR DS 3558 latex, and 20 lbs, as is, of Laurel AD-10A PTFE Dispersion the tank was filled to 50 gals with water and the mixture fed to a spray header having a ration of 35 binder/20 water. The material was pulped for 5 minutes after the addition of 664 gallons water, 64.1 wet lbs. of Eftec A040-6 Acrylic Fiber and 17.6 wet lbs. of 0.1d×3 mm Vonnel Acrylic Fiber to. Pulp for 5 The material was then dumped and rinsed to PDC with 664 gals of water before being fed to a machine chest to hold level above 4 ft. The feed to the machine chest was to suction side of fan pump @ 24.0 gpm and 40 Hz. The machine was 26.5″ deckle, pond in, dandy on, agitator in headbox with the settings being: flow valve ½ open, control level with Hz. (start @ 15); full vacuum all boxes; speed=27.0 fpm; full steam all cans; and wind to length in the objective.

The physical property data for the material produced in this trial is presented in Table 6.

TABLE 6

| | | Minimum | Maximum | Number of |
|---|---|---|---|---|
| | Average | Value | Value | Samples |
| Property | Value | Observed | Observed | tested |
| Basis Weight | 28.9 | 27.7 | 30.0 | 10 |
| (lbs/3000) | | | | |
| Dielectric Strength | 279 | 273 | 284 | 15 |
| in Air (V/mil) | | | | |
| Dielectric Strength | 425 | 310 | 685 | 15 |
| in Oil (V/mil) | | | | |
| MD Tensile (g/m) | 6723 | 5941 | 7563 | 10 |
| CD Tensile (g/m) | 3273 | 2953 | 3629 | 10 |
| MD Elongation (%) | 28.5 | 22.3 | 35.5 | 10 |
| CD Elongation (%) | 28.4 | 23.0 | 35.7 | 10 |

The results demonstrate that an EIS of the type described herein displays high dielectric strengths in both air and oil.

### Prophetic Example

The EIS of example 3 will be subjected to the following additional processing procedures (1) hot calendering, (2) microcreping, (3) hot calendering followed by microcreping and (4) microcreping followed by hot calendering. The physical properties of the sheets subjected to processees (1)-(4) will be compared to those of a sheet not subjected to additional processing procedures. Sheets subjected to additional processing procedures are predicted to display improvements in physical properties when compared to sheets not subjected to additional processing procedures. Particularly, sheets subjected to additional processing are predicted to display increases in dielectric strengths (in air and/or oil).

While embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. Electrical insulation material comprising:
a fiber component,
a binder element, and
a dielectric additive and having a dielectric strength measured in air in the range of from about 8.9 MV/m (225 V/mil) to about 15.7 MV/m (325 V/mil), a dielectric strength measured in oil of greater than about 23.6 MV/m (600 V/mil), and a continuous use temperature of from about −30° C. (−22° F.) to about 220° C. (428° F.).

2. The insulation of claim 1, wherein the fiber component comprises acrylic fibers, synthetic fibers, synthetic pulps, lyocell fibers, meta-aramids, para-aramids, polyphenylene sulfide fibers, poly(butylene terephthtalate) fibers, poly(ethylene terephthalate) fibers, polypropylene fibers, polyethylene fibers, fiberglass fibers, clay fiber, or combinations thereof.

3. The insulation of claim 1, wherein the binder element comprises emulsion polymers styrene acrylates, styrene butadienes, acrylics, vinyl acetates, acrylonitriles resins, urethanes, epoxies, urea formaldehyde, melamine formaldehyde, solution polymers, acidified acrylics, polyvinyl alcohols, or combinations thereof.

4. The insulation of claim 1, wherein the dielectric additive comprises fluoropolymers, neoprene, bakelite, silicone or combinations thereof.

5. A sheet or tape formed from the insulation of claim 1.

6. The sheet or tape of claim 5 having a machine direction (MD) tensile strength of from about 10 lbs/inch width (4.5 kg/25.4 mm) to about 100 lbs/inch width (45.4 kg/25.4 mm).

7. The sheet or tape of claim 5 having an elongation value in the machine direction of from about 20% to about 40% and an elongation value in the transverse direction of from about 20% to about 40%.

8. The sheet or tape of claim 5 having mineral oil absorption of from about 100% to about 150%.

9. The sheet or tape of claim 5 having a creped surface.

10. An insulated conductor comprising an electrical conductor wrapped with the sheet or tape of claim 5.

11. A method of making electrical insulation material, comprising:
preparing an aqueous slurry comprising a fiber component;
forming the slurry into a sheet; saturating the sheet with a saturant, wherein the saturant comprises a binder and a dielectric additive; and drying the saturated sheet.

12. The method of claim 11, wherein the fiber component is a fibrillated acrylic fiber and is present in the slurry in an amount of from about 0.1 (w/w) % to about 3.0 (w/w) %; the binder element is a carboxylated styrene-acrylate copolymer and is present in the saturant in an amount of from about 10 (w/w) % to about 20 (w/w) %; and the dielectric additive is a fluoropolymer dispersion and is present in the saturant in an amount of from about 1 (w/w) % to about 10 (w/w) %.

13. The method of claim 12 wherein the saturant further comprises a wetting agent in an amount of from about 0.05 (w/w) % to about 2.00 (w/w) %.

14. The method of claim 12, further comprising uniaxially or biaxially orienting the fibers in the sheet.

15. The method of claim 12, further comprising creping and/or calendering the sheet.

16. Electrical insulation prepared by the process of claim 12.

17. A method comprising:
preparing an aqueous slurry comprising a fibrillated acrylic fiber;
dilution hydroforming the slurry into a sheet;
saturating the sheet with a saturant, wherein the saturant comprises a carboxylated styrene-acrylate copolymer and a fluoropolymer; drying the sheet; and
providing the sheet for use as insulation on an electrical conductor.

18. The method of claim 17, wherein the electrical conductor is housed within an oil-filled transformer, wherein the oil is at a temperature of from about 100° C. (212° F.) to about 220° C. (428° F.).

19. The method of claim 17, further comprising creping and/or calendering the sheet.

20. A method comprising:
obtaining an electrical insulation sheet or tape comprising a fibrillated acrylic fiber, a carboxylated styrene-acrylate copolymer and a fluoropolymer;
covering at least a portion of an electrical conductor with the sheet or tape; and
providing the electrical conductor for use in oil-filled electric transformers, wherein the oil is at a temperature of from about 100° C. (212° F.) to about 220° C. (428° F.).

21. The method of claim 20, wherein the electrical insulation has a dielectric strength measured in air in the range of from about 8.9 MV/m (225 V/mil) to about 12.8 MV/m (325 V/mil), a dielectric strength measured in oil in the range of greater than about 23.6 MV/m (600 V/mil).

22. A method comprising:
forming a sheet comprising a fibrillated acrylic fiber, a carboxylated styrene-acrylate copolymer and a fluoropolymer;
creping and/or hot calendering the sheet; and
providing the sheet for use as insulation on an electrical conductor.
